(19) United States
(12) Patent Application Publication
(10) Pub. No.: US 2014/0372218 A1
(43) Pub. Date: Dec. 18, 2014

(54) SELECTIVE PLACEMENT OF PROMOTIONAL ELEMENTS WITHIN SEARCH RESULT LAYOUT

(71) Applicant: Microsoft Corporation, Redmond, WA (US)

(72) Inventors: Madhusudhan K. Talluri, Bellevue, WA (US); Jerel Frauenheim, Seattle, WA (US); Matthew Thomas Herbst, Bellevue, WA (US); Christopher Rizzuto, Newcastle, WA (US); Hrishikesh Bal, Bellevue, WA (US); Alec John Berntson, Bellevue, WA (US); Wai Chan, Bellevue, WA (US); Jasen Peterman, Bellevue, WA (US)

(21) Appl. No.: 13/918,239

(22) Filed: Jun. 14, 2013

(51) Int. Cl. G06Q 30/02; G06F 17/30

(52) U.S. Cl. CPC G06Q 30/0256; G06F 17/30554
USPC 705/14.54

(57) ABSTRACT

One or more techniques and/or systems are provided for selective placement of promotional elements within a search result layout. For example, a search result layout may be constructed with one or more search results relevant to a search query (e.g., images, websites, and/or other content associated with a “vacation” search query). Promotional elements may be retrieved based upon the search query, and display ranks may be assigned to such promotional elements based upon various ranking factors, such as user engagement, search result correlation, and/or relevancy, etc. In this way, promotional elements may be interspersed amongst search results within the search result layout based upon display ranks (e.g., a download vacation app promotional element may be assigned to a layout portion between a first search result and a second search result). Because promotional elements may be interspersed with search results, visual labels may be assigned to promotional elements (e.g., “AD”).

### BACKGROUND

Many users discover, explore, and/or interact with content exposed by search interfaces. In an example, a search engine website may provide a user with search results, such as web pages, images, or other content, that may be relevant to a search query submitted by the user. In another example, an operating system search interface may identify and expose files to a user based upon a search query submitted through the operating system search interface. In this way, users may efficiently locate content that may be relevant (e.g., relevant to the search query) and/or useful (e.g., useful for accomplishing a search task, such as planning a vacation).

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for selective placement of promotional elements within a search result layout are provided herein. For example, a search query may be received through a search interface (e.g., a user may input “beach vacations” into an operating system search interface, such as a search charm). A set of search results may be retrieved based upon the search query (e.g., images, websites, applications, music, blogs, and/or other content relevant to the search query “beach vacations”). A set of promotional elements may be retrieved based upon the search query (e.g., advertisements, promotional images, applications available through an app store, multimedia such as music or videos available through a multimedia store, and/or a variety of other promotional content relevant to the search query “beach vacations”). For example, the set of promotional elements may comprise a first promotional element, a second promotional element, and/or other promotional elements.

Display ranks may be specified for promotional elements within the set of promotional elements based upon user promotional content engagement (e.g., an amount or percentage of users that choose to interact with a promotional element as opposed to ignore the promotional element), search result correlation (e.g., how relevant a promotional element may be to a search result within the set of search results), and/or a relevancy to the search query. For example, a first display rank may be specified for the first promotional element (e.g., a relatively high ranking, such as a display rank of 9 out of 10, may be specified for a Cancun vacation advertisement based upon relatively high user engagement due to a current spring vacation season) and a second display rank may be specified for the second promotional element (e.g., a relatively low ranking, such as a display rank of 2 out of 10, may be specified for a skiing vacation advertisement based upon relatively low user engagement due to a lack of snow during the spring season).

A search result layout may be defined for the set of search results. The search result layout may comprise a layout of at least some of the search results within the set of search results. Promotional elements within the set of promotional elements may be assigned to layout portions of the search result layout based upon display ranks (e.g., promotional elements may be interspersed between search results within the search result layout). For example, the first promotional element may be assigned to a third layout portion based upon the first display rank (e.g., corresponding to a third operating system search interface tile) and the second promotional element may be assigned to a fifth layout portion based upon the second display rank (e.g., corresponding to a fifth operating system search interface tile). In an example, the third layout portion and/or fifth sixth layout portion may be interspersed between one or more search results within the search result layout (e.g., a first search result may be oriented in a first layout portion; a second search result may be oriented in a second layout portion adjacent, such as below, the first layout portion; the first promotional element may be oriented in the third layout portion adjacent, such as below, the second layout portion based upon the first display rank having a relatively higher rank than the second display rank of the second promotional element; a third search result may be oriented in a fourth layout portion adjacent, such as below, the third layout portion; the second promotional element may be oriented in a fifth layout portion adjacent, such as below, the fourth layout portion based upon the second display rank having a relatively lower rank than the first display rank of the first promotional element, etc.). Because promotional elements may be interspersed between search results within the search result layout, the promotional elements may be identified as promotional content (e.g., a visual label, such as “AD”, “Promotional Content”, etc., may be assigned to a promotional element). In this way, the search result layout may be displayed as an interactive search result interface through the search interface (e.g., a continuously navigable set of search results having promotional elements interspersed therein).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of selective placement of promotional elements within a search result layout.

FIG. 2 is a component block diagram illustrating an exemplary system for surfacing one or more promotional elements as search query suggestions through a search interface.

FIG. 3 is a component block diagram illustrating an exemplary system for selective placement of promotional elements within a search result layout.

FIG. 4 is a component block diagram illustrating an exemplary system for selective placement of promotional elements within a search result layout.

FIG. 5 is a component block diagram illustrating an exemplary system for selective placement of promotional elements within a search result layout.

FIG. 6 is an illustration of an example of displaying promotional elements according to various display modes.

FIG. 7 is an illustration of an exemplary computer readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

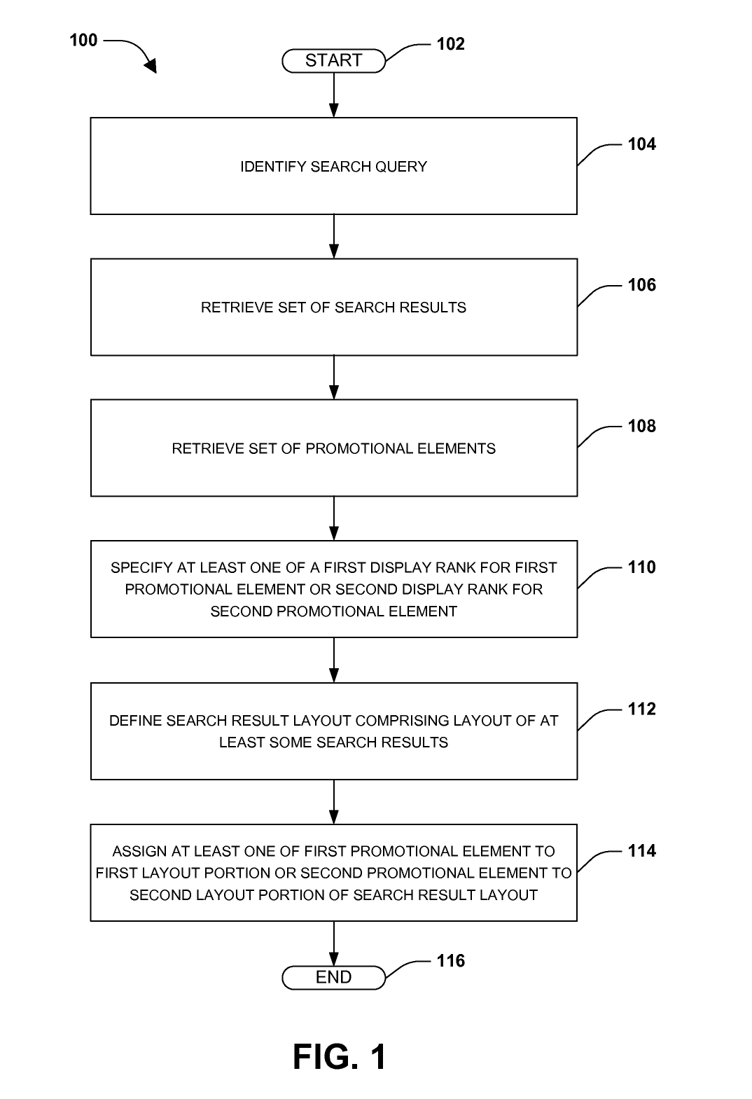

An embodiment of selective placement of promotional elements within a search result layout is illustrated by an exemplary method 100 of FIG. 1. At 102, the method starts. A search interface may be hosted by a computing device, such as a tablet device, a mobile device, a desktop device, etc. In an example, the search interface may correspond to a web browser accessing a search website. In another example, the search interface may correspond to a search application hosted on a local device. In another example, the search interface may correspond to an operating system search interface (e.g., a search charm integrated into an operating system of the computing device). At 104, a search query received through the search interface may be identified (e.g., a search query “Hard Rock Band upcoming tour”). For example, the search query may be identified based upon a search initialization command used to invoke the operating system search interface (e.g., a user typing event where a user begins to type while at an operating system home interface; a swipe gesture or other touch input that may be mapped to the operating system search interface; a hardware button press mapped to the operating system search interface; a click input on a portion of the screen mapped to operating system search interface; etc.). In an example where the search query corresponds to a partial search query (e.g., during search query formulation/typing by the user), a promotional element corresponding to the partial search query may be surfaced as a promotional element suggestion (e.g., an advertisement operating system tile may be displayed through the operating system search interface).

At 106, a set of search results may be retrieved based upon the search query. For example, images, websites, and/or other content relevant to the search query may be retrieved (e.g., retrieved from a search engine). At 108, a set of promotional elements may be retrieved based upon the search query. For example, advertisements, applications available for download, multimedia content such as music or videos available for purchase, an ability to complete a transaction (e.g., buy concrete tickets, make a table reservation at a restaurant, book a hotel, purchase an item through a marketplace, and/or a plethora of other transactions), and/or other promotional content relevant to the search query may be retrieved. The set of promotional elements may comprise a first promotional element (e.g., a music fan club subscription promotional element), a second promotional element (e.g., a purchase interface promotional element for concert tickets), and/or other promotional elements.

Display ranks may be specified for promotional elements within the set of promotional elements. A displaying ranking technique may take into account user promotional content engagement (e.g., an amount or percentage of users that interact with a promotional element when given the opportunity), search result correlation (e.g., how related a promotional element is to a search result within the set of search results), a relevancy to the search query, personalization settings specified by a user (e.g., a personalization on/off setting associated as to whether promotional elements are to be based upon personal information of the user; a personalization time span such as to have personalized promotional elements for a particular number of days; personalization based upon prior user information; personalization based upon current and future user information; personalization based upon local file data; etc.), and/or other various factors. In an example, the display ranking technique may take into account a comparison of a cloud rank and a local client rank (e.g., a cloud rank assigned by a cloud ranking technique that takes into account user engagement by a plurality of users vs. a local rank corresponding to how relevant a promotional element is to information about the user of the device, such as local concert ticket files or music files locally stored on the device). In this way, display rankings may be specified based upon various factors. At 110, a first display rank may be specified for the first promotional element (e.g., a relatively low display rank may be assigned to the music fan club subscription promotional element because users may have low user engagement with the music fan club subscription promotional element) and/or a second display rank may be specified for the second promotional element (e.g., a relatively high display rank may be assigned to the purchase interface promotional element because users may have high user engagement with the purchase interface promotional element).

At 112, a search result layout comprising a layout of at least some of the search results within the set of search results may be defined (e.g., the layout may correspond to an arrangement of search results and/or promotional elements that may be displayed through the search interface). For example, search results may be arranged within the search result layout according to relevancy rankings (e.g., search results having relatively high relevancy to the search query may be arranged in a prominent view location such that a user may see such high relevancy search results sooner; search results having relatively low relevancy to the search query may be arranged in less prominent view locations such that the user may see such low relevancy search results after seeing the high relevancy search results).

Promotional elements within the set of promotional elements may be assigned to layout portions of the search result layout based upon display rankings. For example, promotional elements may be interspersed between search results within the search result layout (e.g., a promotional element may be arranged/oriented between a first search result and a second search result). At 114, the first promotional element may be assigned to a first layout portion of the search result layout based upon the first display rank (e.g., the music fan club subscription promotional element may be assigned to a relatively less prominent portion of the search result layout, such as a fifteenth position based upon the relatively low display rank), and the second promotional element may be assigned to a second layout portion of the search result layout based upon the second display rank (e.g., the purchase interface promotional element may be assigned to a relatively prominent portion of the search result layout, such as a third position based upon the relatively high display rank).

It may be appreciated that promotional elements may be arranged according to a variety of arrangement layouts. In an example, the first layout portion comprising the first promotional element may be arranged/oriented between a first search result and a second search result. In another example, the first layout portion comprising the first promotional element may be arranged/oriented adjacent to the second layout portion comprising the second promotional element. In another example, one or more search results may be arranged/oriented between the first layout portion comprising the first promotional element and the second layout portion comprising the second promotional element. In another example, the first layout portion comprising the first promotional element may be arranged/oriented adjacent to a search result with which the first promotional element has a relatively high search result correlation. In another example, the first search result may be assigned to a first operating system interface tile, the second search result may be assigned to a third operating system interface tile, and the first promotional element may be assigned to a second operating system interface tile oriented between the first operating system interface tile and the third operating system interface tile. Because promotional elements may be interspersed amongst search results, visual labels may be assigned to the promotional elements assigned to the search result layout (e.g., “AD”, “Promotional Content”, and/or other identifiers may be associated with promotional elements).

In another example of assigning promotional elements to the search result layout, an entity layout pane of the search result layout may be identified. The entity layout pane may comprise entity related content corresponding to an entity (e.g., a particular person, business, music band, actress, city, tourist spot, etc.) identified from the search query. For example, the entity related content may comprise an entity picture, an entity biography, an entity app exposed for purchase (e.g., a sports app associated with a sports company entity), an entity song exposed for preview or purchase, an entity video exposed for preview or purchase, a link to additional entity related content (e.g., a fan website), and/or a variety of other content or information. In an example, a promotional element may be assigned to a portion of the entity layout pane based upon a display rank assigned to the promotional element (e.g., the display rank may have a very high rank, such that the promotional element may be arranged/oriented within the entity layout pane for prominent display to a user because the entity layout pane may be displayed at a first position). In another example, the entity layout pane may be replaced with the promotional element so that the promotional element may be displayed in a prominent location to a user (e.g., within the entity layout pane that may be sized relatively larger than other search results).

In this way, the search result layout or a portion thereof may be displayed through the search interface. The search result layout may be displayed according to a display mode, such as a portrait display mode or a landscape display mode. In an example, a promotional element may be displayed differently depending on a current display mode (e.g., more, less, and/or different promotional sub-elements, such as text, images, links, and other content, of the promotional element may be displayed). For example, the music fan club subscription promotional element may comprise a set of promotional sub-elements, such as a fan club image promotional sub-element, a band image promotional sub-element, a fun club description promotional sub-element, a subscription interface promotional sub-element, a buy tickets promotional sub- element, and/or other promotional sub-elements. A first portion of the set of promotional sub-elements may be displayed through the search result layout according to a first display mode, such as a portrait display mode of a tablet or mobile device (e.g., the fan club image promotional sub-element and the fan club description promotional sub-element may be displayed). Responsive to a transition from the first display mode to a second display mode such as a landscape display mode of the tablet or mobile device, a second portion of the set of promotional sub-elements may be displayed through the search result layout according to the second display mode (e.g., the fan club image promotional sub-element, the band image promotional sub-element, the subscription interface promotional sub-element, and the buy tickets promotional sub-element may be displayed). In this way, promotional elements may be interspersed with and/or visually identified from search results through a search interface, such as an operating system search result interface (e.g., a search charm). At 116, the method ends.

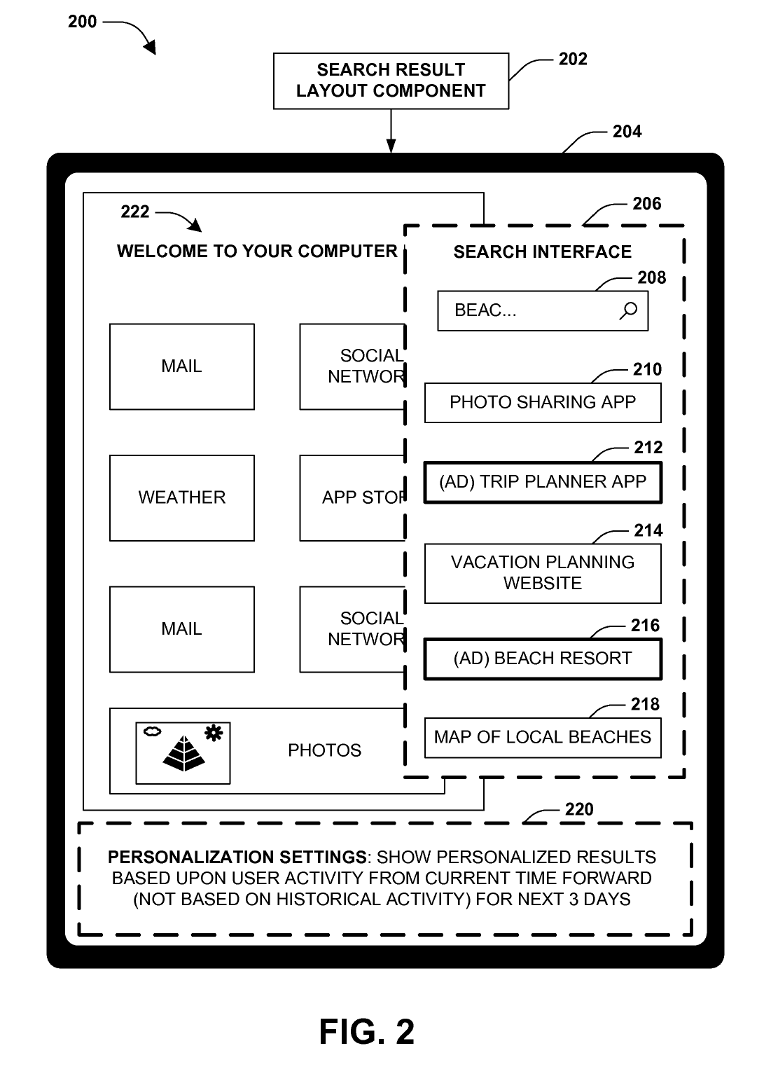

FIG. 2 illustrates an example of a system 200 for surfacing one or more promotional elements as promotional element suggestions through a search interface 206. The system 200 may comprise a search result layout component 202 associated with a computing device 204, such as a tablet. The computing device 204 may host an operating system with an operating system home interface 222. In an example, the operating system may host a search interface 206 (e.g., the operating system may own and/or maintain the search interface 206 as an operating system search interface, such as a search charm). It may be appreciated that the search interface 206 is not limited to being hosted by the operating system, and that the search interface may correspond to various interfaces, such as a search engine website, a search app, a social network search interface, a photo sharing search interface, a file search interface, and/or a plethora of other interfaces that may facilitate searching for content.

In an example, the search result layout component 202 may expose a personalization settings interface 220 through which a user may specify various personalization settings for receiving personalized promotional elements (e.g., promotional elements that may be tailored to interests of the user). For example, the user may specify that personalized results, such as promotional elements, are to be provided based upon user activity from a current time forward for the next 3 days, and that historical activity by the user is not to be taken into account. In this way, a user personalization setting may correspond to a personalization off setting, a personalization on setting, a personalize based upon prior information setting (e.g., based upon a user profile), a personalization based upon future user information setting (e.g., based upon user browsing activity, files on the computing device 204, a social network profile, a photo sharing profile, a cloud profile, emails, calendar entries, etc.), a personalization based upon local file data setting (e.g., emails, music files, calendar entries, system settings, installed applications, and/or a variety of other local information such as files on the computing device 204), and/or a personalize time span setting (e.g., in an attempt to accomplish a search task, such as planning a vacation within the next 3 days, the user may desire to have promotional elements displayed based upon personalized information for the next 3 days).

In an example, the user may invoke the search interface 206 (e.g., the user may begin typing while at least some of the operating system home interface 222 remains visible). The user may formulate a search query through a search query input interface 208. During query formulation (e.g., where the user has typed “beac” of the search query as a partial search query), one or more query suggestions, search result suggestions, and/or promotion element suggestions may be displayed. For example, a photo sharing app search result suggestion 210, a vacation planning website search result suggestion 214, and a map of local beaches search result suggestion 218 may be displayed. A trip planner app promotional element 212 (e.g., an ability for the user to purchase a trip planner app from an app store) and a beach resort promotional element 216 (e.g., a link to a beach resort website) may be displayed as promotional element suggestions within the search interface 206 based upon the partial search query “beac”. In an example, visual labels (e.g., “AD”) may be assigned to the trip planner app promotional element 212 and the beach resort promotional element 216 to identify such promotional elements as promotional content as opposed to search result suggestions and/or query suggestions.

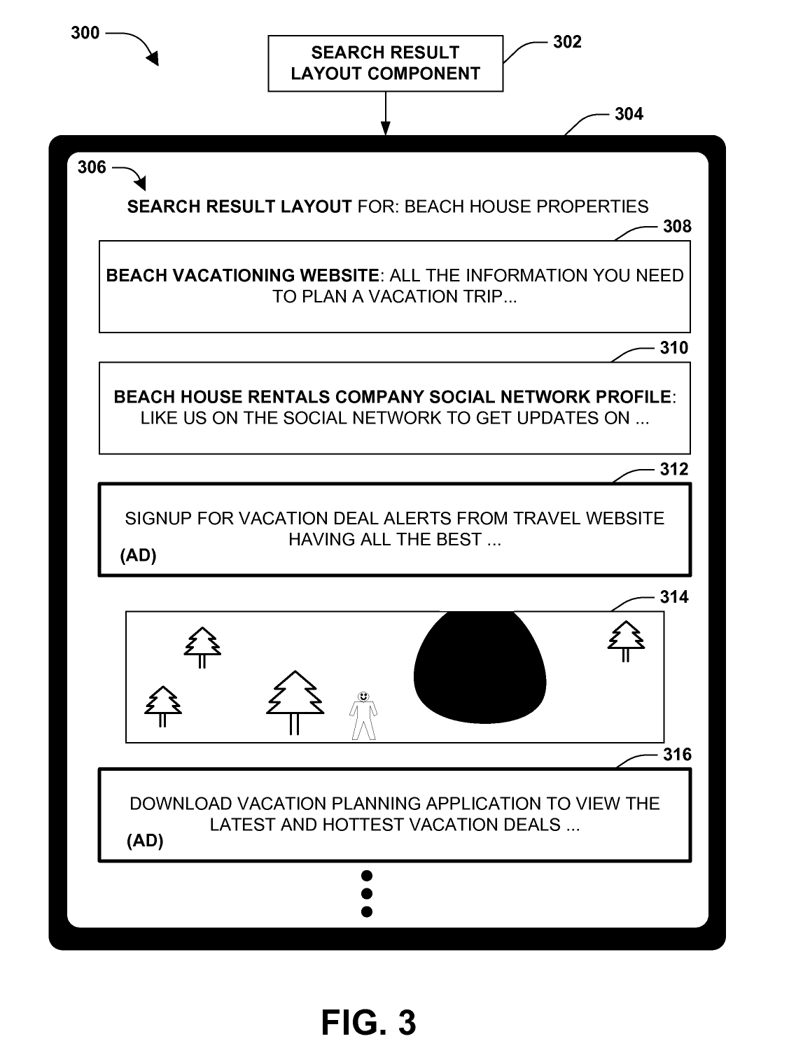

FIG. 3 illustrates an example of a system 300 for selective placement of promotional elements within a search result layout 306. The system 300 may comprise a search result layout component 302 associated with a computing device 304. The search result layout component 302 may be configured to identify a search query received through a search interface, such as a search query “beach house properties”. The search result layout component 302 may retrieve a set of search results based upon the search query, such as a beach vacation website search result 308, a beach house rentals company social network profile search result 310, a beach image search result 314, and/or other search results relevant to the search query “beach house properties”. The search result layout component 302 may be configured to retrieve a set of promotional elements based upon the search query, such as a vacation deals promotional element 312, a download vacation planning application promotional element 316, and/or other promotional elements.

The search result layout component 302 may specify display ranks for the promotional elements. For example, a relatively high display rank may be specified for the vacation deals promotional element 312 and a relatively low display rank may be specified for the download vacation planning application promotional element 316 based upon various ranking factors (e.g., user promotional content engagement associated with users interacting with the vacation deals promotional element 312; search result correlation associated with how relevant the vacation deals promotional element 312 is to a search result; and/or a relevancy to the search query “beach house properties”; etc.). For example, a relatively large amount of users may sign up for vacation deals through the vacation deals promotional element 312, while the vacation planning application may have a relatively low rating through an app store and thus low user engagement.

The search result layout component 302 may be configured to define the search result layout 306 comprising a layout of at least some search results. The search result layout component 302 may assign promotional elements to layout portions of the search result layout 306 based upon display ranks. For example, the vacation deals promotional element 312 may be assigned to a third layout portion between the beach house rentals company social network profile search result 310 at a second layout portion and the beach image search result 314 at a fourth layout portion based upon the relatively high display rank assigned to the vacation deals promotional element 312. The download vacation planning application promotional element 316 may be assigned to a fifth layout portion after the beach image search result 314 at a fourth layout portion based upon the relatively low display rank assigned to the download vacation planning application promotional element 316. In an example, visual labels (e.g., “AD”) may be assigned to promotional elements within the search result layout 306. In this way, promotional elements may be interspersed amongst search results within the search result layout 306.

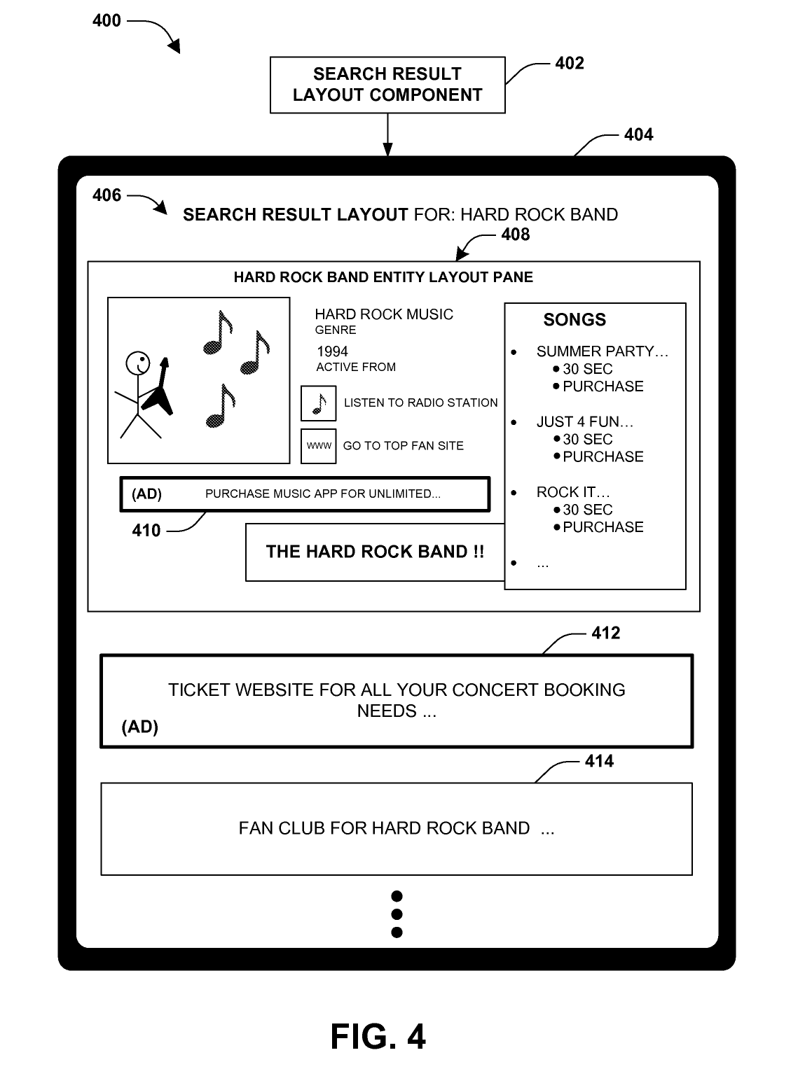

FIG. 4 illustrates an example of a system 400 for selective placement of promotional elements within a search result layout 406. The system 400 may comprise a search result layout component 402 associated with a computing device 404. The search result layout component 402 may be configured to identify a search query received through a search interface, such as a search query “Hard Rock Band”. The search result layout component 402 may retrieve a set of search results based upon the search query, such as a fan club website search result 414, and/or other search results relevant to the search query “Hard Rock Band”. In an example, the search result layout component 402 may create a customized interface for an entity associated with the search query, such as a Hard Rock Band entity. For example, the search result layout component 402 may create a Hard Rock Band entity layout pane 408 comprising entity related content, such as images, songs for purchase, biography information, and/or other information associated with the Hard Rock Band entity. The search result layout component 402 may define the search result layout 406 comprising the Hard Rock Band entity layout pane 408 at a first layout portion, the fan club website search result 414 at a third layout portion, and/or other search results at other layout portions.

The search result layout component 402 may be configured to retrieve and/or assign display ranks to a set of promotional elements based upon the search query, such as a purchase music app promotional element 410, a ticket website promotional element 412, and/or other promotional elements. The search result layout component 402 may assign the purchase music app promotional element 410 to a portion of the Hard Rock Band entity layout pane 408, such as between an image of the Hard Rock Band and a logo for the Hard Rock Band. The search result layout component 402 may assign the ticket website promotional element 412 to a second layout portion between the Hard Rock Band entity layout pane 408 and the fan club website search result 414. In an example, visual labels (e.g., “AD”) may be assigned to promotional elements within the search result layout 406. In this way, promotional elements may be interspersed amongst search results and/or within an entity layout pane within the search result layout 406.

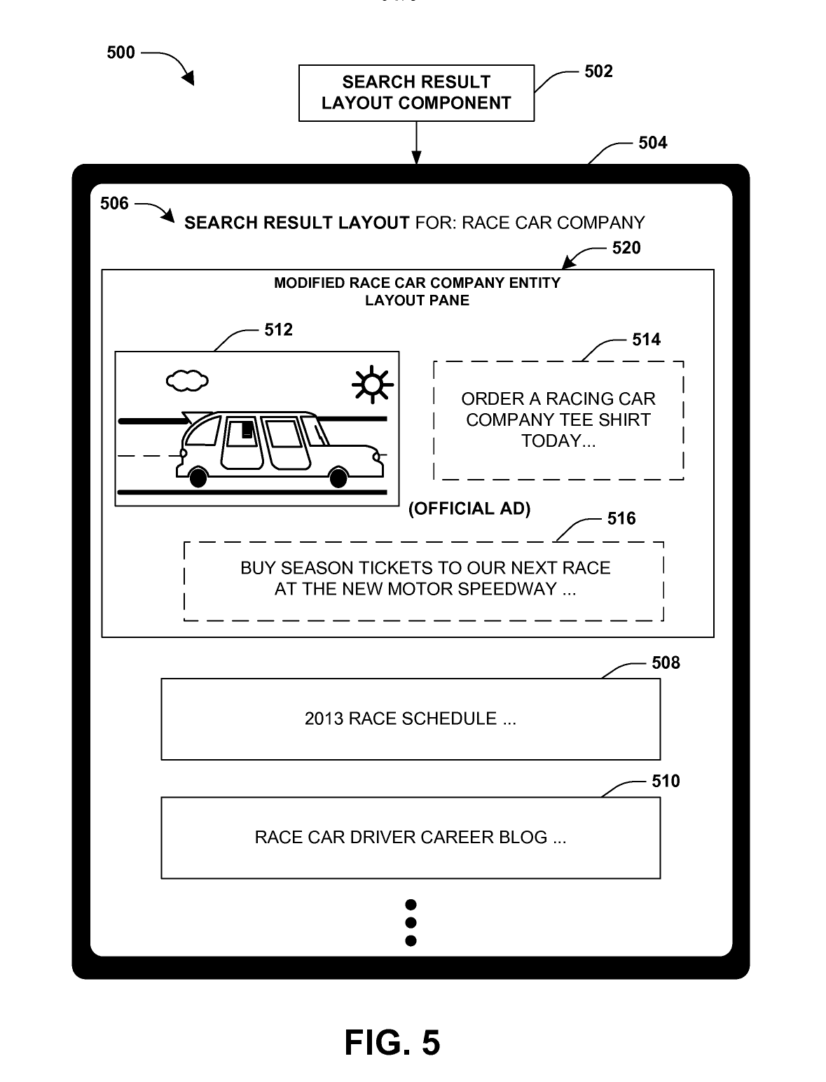

FIG. 5 illustrates an example of a system 500 for selective placement of promotional elements within a search result layout 506. The system 500 may comprise a search result layout component 502 associated with a computing device 504. The search result layout component 502 may be configured to identify a search query received through a search interface, such as a search query “Race Car Company”. The search result layout component 502 may retrieve a set of search results based upon the search query, such as a 2013 race schedule search result 508, a race car driver career blog search result 510, and/or other search results relevant to the search query “Race Car Company”. In an example, the search result layout component 502 may create a customized interface for an entity associated with the search query, such as a Race Car Company entity. For example, the search result layout component 502 may create a Race Car Company entity layout pane comprising entity related content for the Race Car Company entity.

The search result layout component 502 may be configured to retrieve and/or assign display ranks to a set of promotional elements based upon the search query, such as an official Race Car Company promotional element comprising a company logo promotional sub-element 512, an order tee shirt promotional sub-element 514, and/or a buy season tickets promotional sub-element 516. In an example, the Race Car Company entity layout pane may be replaced with the official Race Car Company promotional element (e.g., based upon the official Race Car Company promotional element having a relatively high display rank due to being official promotional content associated with the Race Car Company entity) to create a modified official Race Car Company entity layout pane 520 that may be assigned to a first layout portion of the search result layout 506. In an example, a visual label (e.g., “Official AD”) may be assigned to the modified official Race Car Company entity layout pane 506. In this way, an entity layout pane may be replaced with a promotional element (e.g., to create an entity pane comprising more “official” content).

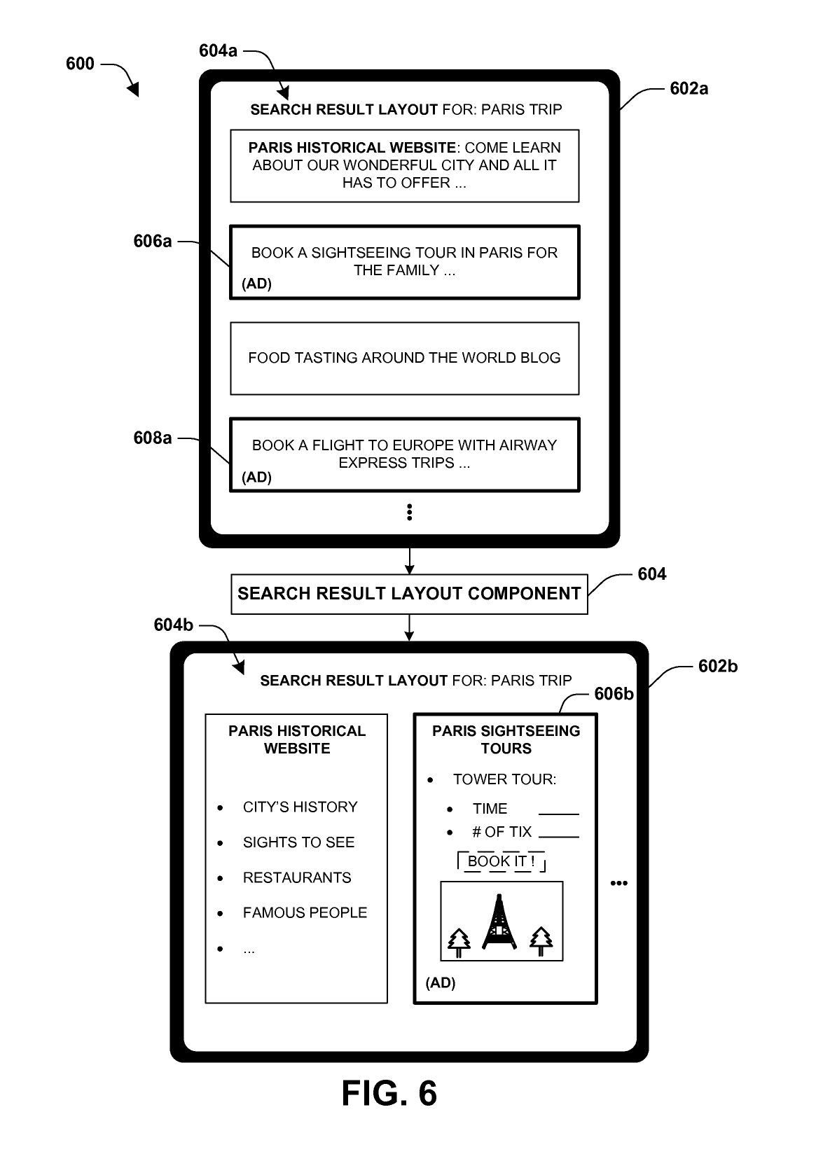

FIG. 6 illustrates an example 600 of displaying promotional elements according to various display modes. In an example, a search result layout component 604 may display a search result layout 604a according to a portrait display mode on a computing device 602a (e.g., based upon the computing device 602a, such as a tablet or mobile device, being held according to a portrait orientation). One or more promotional elements, such as a Paris sightseeing tours promotional element 606a and a flight booking promotional element 608a, may be displayed according to the portrait display mode (e.g., merely textual description promotional sub-elements may be displayed for the Paris sightseeing tours promotional element 606a and the flight booking promotional element 608a). Responsive to detecting a transition from the portrait display mode to a landscape display mode (e.g., based upon the computing device 602a being rotate to a landscape position, resulting in a computing device 602b), the search result layout 604a may be modified according to the landscape display mode, resulting in a search result layout 604b. For example, the Paris sightseeing tours promotional element 606a may be modified according to the landscape display mode, resulting in a Paris sightseeing tours promotional element 606b (e.g., a Paris sightseeing image, a tower tour booking interface, and/or other promotional sub-elements may be populated within the Paris sightseeing tours promotional element 606b). In this way, promotional elements may be modified (e.g., promotional sub-elements may be displayed, hidden, modified, etc.) based upon transitions between display modes.

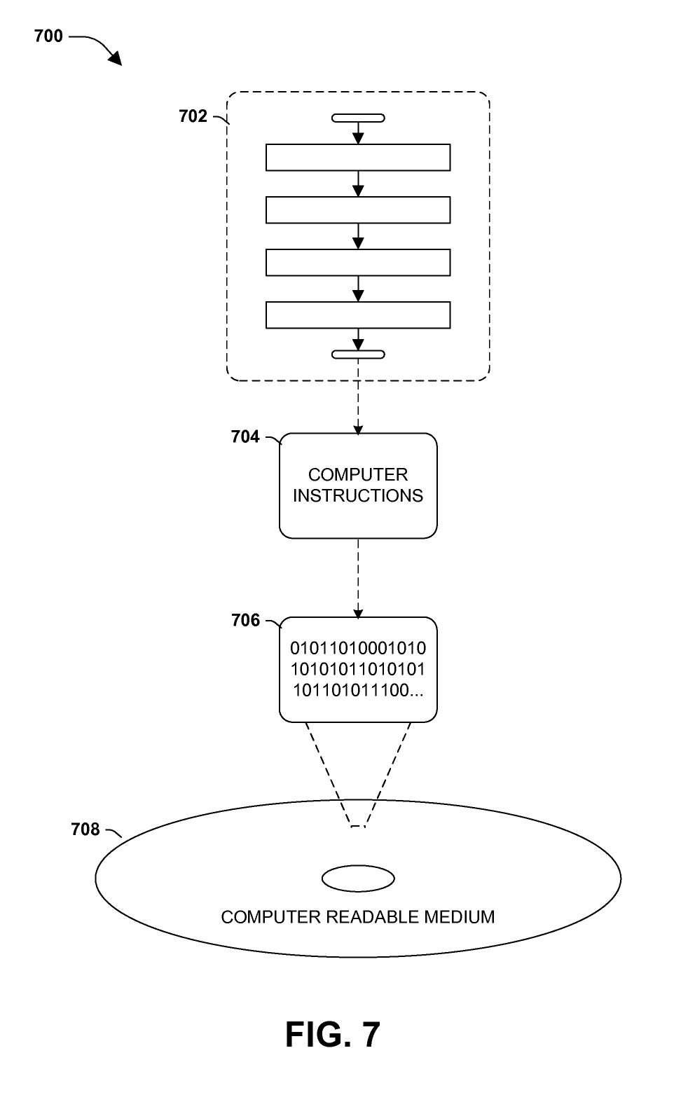

Still another embodiment involves a computer-readable medium comprising processor-executable instructions configured to implement one or more of the techniques presented herein. An example embodiment of a computer-readable medium or a computer-readable device that is devised in these ways is illustrated in FIG. 7, wherein the implementation 700 comprises a computer-readable medium 708, such as a CD-R, DVD-R, flash drive, a platter of a hard disk drive, etc., on which is encoded computer-readable data 706. This computer-readable data 706, such as binary data comprising at least one of a zero or a one, in turn comprises a set of computer instructions 704 configured to operate according to one or more of the principles set forth herein. In some embodiments, the processor-executable computer instructions 704 are configured to perform a method 702, such as at least some of the exemplary method 100 of FIG. 1, for example. In some embodiments, the processor-executable instructions 704 are configured to implement a system, such as at least some of the exemplary system 200 of FIG. 2, at least some of the exemplary system 300 of FIG. 3, at least some of the exemplary system 400 of FIG. 4, and/or at least some of the exemplary system 500 of FIG. 5, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

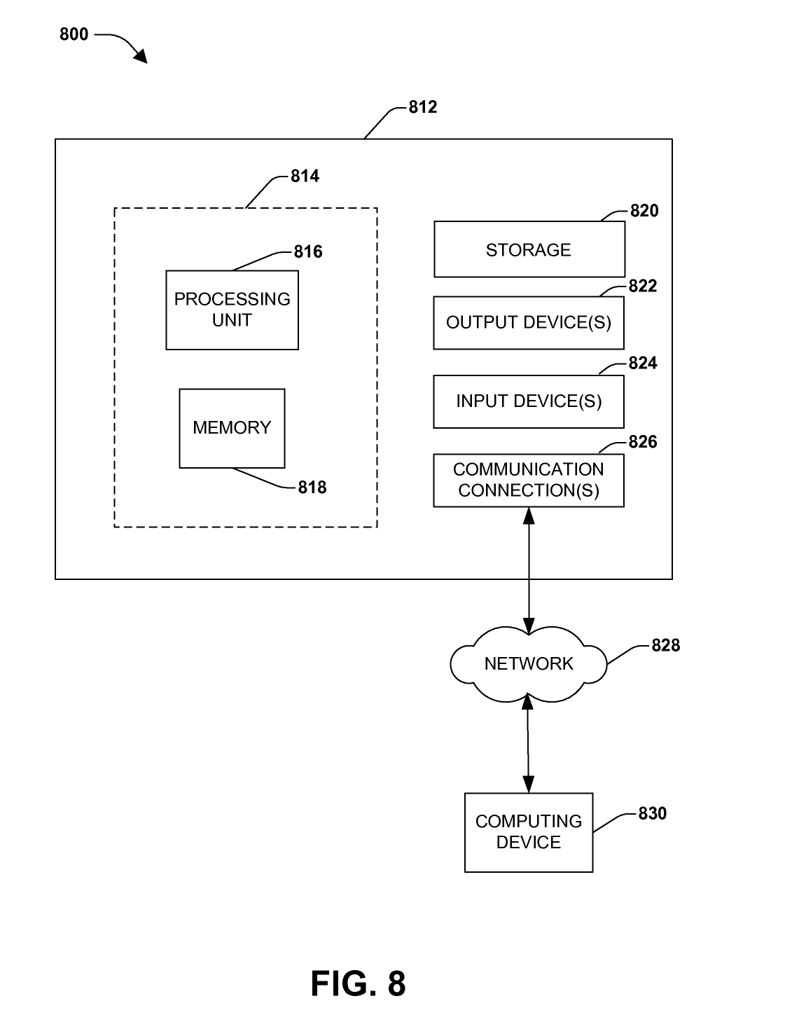

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application.

What is claimed is:

1. A method for selective placement of promotional elements within a search result layout, comprising:
identifying a search query received through a search interface;
retrieving a set of search results based upon the search query;
retrieving a set of promotional elements based upon the search query, the set of promotional elements comprising at least one of a first promotional element or a second promotional element;
specifying at least one of a first display rank for the first promotional element or a second display rank for the second promotional element, the specifying comprising specifying based upon at least one of user promotional content engagement, search result correlation, or relevancy to the search query;
defining a search result layout comprising a layout of at least some of the search results within the set of search results; and
assigning at least one of the first promotional element to a first layout portion of the of the search result layout based upon the first display rank or the second promotional element to a second layout portion of the search result layout based upon the second display rank.

2. The method of claim 1, the search interface comprising an operating system search interface, and the identifying a search query comprising:
identifying a search initialization command to invoke the operating system search interface based upon at least one of a user typing event associated with an operating system home interface, a swipe gesture, a hardware button press, or a click input.

3. The method of claim 1, at least one of the first layout portion or the second layout portion oriented between a first search result and a second search result.

4. The method of claim 1, comprising:
assigning a visual label to at least one of the first promotional element or the second promotional element, the visual label identifying at least one of the first promotional element or the second promotional element as comprising promotional content and not a search result.

5. The method of claim 3, the first search result assigned to a first operating system interface tile, the second search result assigned to a third operating system interface tile, and at least one of the first promotional element or the second promotional element assigned to a second operating system interface tile, the second operating system interface tile oriented between the first operating system interface tile and the third operating system interface tile.

6. The method of claim 1, the search query corresponding to a partial search query, and the method comprising:
surfacing a third promotional element within the set of promotional elements as a promotional element suggestion.

7. The method of claim 1, the assigning comprising:
identifying an entity layout pane of the search result layout, the entity layout pane comprising entity related content corresponding to an entity identified from the search query; and
assigning a third promotional element to a portion of the entity layout pane based upon a third display rank assigned to the third promotional element.

8. The method of claim 7, the entity related content comprising at least one of an entity picture, an entity biography, an entity app exposed for purchase, an entity song exposed for preview or purchase, an entity video exposed for preview or purchase, or a link to additional entity related content.

9. The method of claim 1, the second display rank having a lower ranking than the first display rank, the first layout portion oriented before the second layout portion within the search result layout, one or more search results oriented between the first layout portion and the second layout portion within the search result layout.

10. The method of claim 1, the assigning comprising:
identifying an entity layout pane of the search result layout, the entity layout pane comprising entity related content corresponding to an entity identified from the search query; and
replacing the entity layout pane with a third promotional element.

11. The method of claim 1, comprising:
displaying the search result layout through the search interface according to a display mode.

12. The method of claim 11, the display mode corresponding to at least one of a portrait display mode or a landscape display mode.

13. The method of claim 1, at least one of the first promotional element or the second promotional element comprising a set of promotional sub-elements, and the method comprising:
displaying a first portion of the set of promotional sub-elements through the search result layout according to a first display mode; and
responsive to a transition from the first display mode to a second display mode, displaying a second portion of the set of promotional sub-elements through the search result layout according to the second display mode.

14. The method of claim 1, comprising:
identifying a personalization setting specified by a user; and
adjusting a display rank for a promotional element based upon the personalization setting.

15. The method of claim 14, the personalization setting corresponding to at least one of a personalization off setting, a personalization on setting, a personalize based upon prior user information setting, a personalize based upon future user information setting, a personalization based upon local file data setting, or a personalize time span setting.

16. The method of claim 14, the adjusting comprising:
adjusting based upon a combination of a cloud rank and a local client rank, the cloud rank corresponding to promotional content engagement by a plurality of cloud users, the local client rank corresponding to user information extracted from a local client device hosting the search interface.

17. A system for selective placement of promotional elements within a search result layout, comprising:
a search result layout component configured to:
identify a search query received through a search interface;
retrieve a set of search results based upon the search query;
retrieve a set of promotional elements based upon the search query, the set of promotional elements comprising at least one of a first promotional element or a second promotional element;
specify at least one of a first display rank for the first promotional element or a second display rank for the second promotional element, the specifying comprising specifying based upon at least one of user promotional content engagement, search result correlation, or relevancy to the search query;
define a search result layout comprising a layout of at least some of the search results within the set of search results; and
assign at least one of the first promotional element to a first layout portion of the of the search result layout based upon the first display rank or the second promotional element to a second layout portion of the search result layout based upon the second display rank.

18. The system of claim 17, the search result layout component configured to:
assign a visual label to at least one of the first promotional element or the second promotional element, the visual label identifying at least one of the first promotional element or the second promotional element as comprising promotional content and not a search result.

19. The system of claim 18, the first search result assigned to a first operating system interface tile, the second search result assigned to a third operating system interface tile, and at least one of the first promotional element or the second promotional element assigned to a second operating system interface tile, the second operating system interface tile oriented between the first operating system interface tile and the third operating system interface tile.

20. A computer readable medium comprising instructions that when executed perform a method for selective placement of promotional elements within a search result layout, the method comprising:
identifying a search query received through a search interface;
retrieving a set of search results based upon the search query;
retrieving a set of promotional elements based upon the search query, the set of promotional elements comprising at least one of a first promotional element or a second promotional element;
specifying at least one of a first display rank for the first promotional element or a second display rank for the second promotional element, the specifying comprising specifying based upon at least one of user promotional content engagement, search result correlation, or relevancy to the search query;
defining a search result layout comprising a layout of at least some of the search results within the set of search results; and
assigning at least one of the first promotional element to a first layout portion of the of the search result layout based upon the first display rank or the second promotional element to a second layout portion of the search result layout based upon the second display rank.
